(19) United States
(12) Patent Application Publication
(10) Pub. No.: US 2022/0190973 A1
(43) Pub. Date: Jun. 16, 2022

(54) ARRAY FOR WIRED TESTING OF MULTI-INPUT AND MULTI-OUTPUT SIGNALS

(71) Applicant: ARRIS Enterprises LLC, Suwanee, GA (US)

(72) Inventor: Peter G. Khoury, San Francsico, CA (US)

(73) Assignee: ARRIS Enterprises LLC, Suwanee, GA (US)

(21) Appl. No.: 17/548,852

(22) Filed: Dec. 13, 2021

Related U.S. Application Data
(60) Provisional application No. 63/125,580, filed on Dec. 15, 2020.

(51) Int. Cl. H04L 1/24; H04L 1/06; H04B 7/0413

(52) U.S. Cl. CPC H04L 1/244; H04L 1/243; H04B 7/0413; H04L 1/06

(57) ABSTRACT

In an electronic device, N input electrical signals provided to N input connectors result in N output electrical signals corresponding to the N input electrical signals on N of M output connectors, where the N output electrical signals are orthogonal to each other. Moreover, the N input electrical signals result in P output electrical signals corresponding to the N input electrical signals on P of the M output connectors, where the P output electrical signals are orthogonal to each other, but are not orthogonal to the N output electrical signals. The P output electrical signals are linear combinations of the N input electrical signals in which the N input electrical signals have corresponding second phases, where a dot product of a given one of the N output electrical signals with a given one of the P output electrical signals equals a non-zero predefined value.

### CROSS REFERENCE TO RELATED APPLICATIONS

This application claims priority under 35 U.S.C. 119(e) to: U.S. Provisional Application Ser. No. 63/125,580, “Array for Wired Testing of Multi-Input and Multi-Output Signals,” filed on Dec. 15, 2020, by Peter G. Khoury, the contents of which are herein incorporated by reference.

### FIELD

The described embodiments relate to an electronic device and techniques for wired testing of multi-input and multi-output (MIMO) signals.

### BACKGROUND

Radio-frequency (RF) signals used during wireless communication are often tested using wired electronic devices. For example, the wired testing may use an electronic device that provides a phased array of RF electrical signals (which is sometimes referred to as a ‘Butler matrix’). Notably, the electronic device that provides a Butler matrix may have four input SubMinature version A (SMA) connectors and four output SMA connectors. An input RF electrical signal applied to a given input SMA connector may be output on the four output SMA connectors with different 90° phase shifts or rotations, such that the output RF electrical signals are orthogonal to each other. Thus, an input RF electrical signal on input SMA connector #2 may result in: an output RF electrical signal on output SMA connector #1 with a phase of 0°, an output RF electrical signal on output SMA connector #2 with a phase of 90°, an output RF electrical signal on output SMA connector #3 with a phase of 180°, and an output RF electrical signal on output SMA connector #4 with a phase of 270°.

However, when extended to more than four inputs or four outputs (such as four inputs and eight outputs or 4×8, or eight inputs and four outputs or 8×4), only four of the outputs from the electronic device that provides the Butler matrix are orthogonal to each other. This can complicate or impede certain types of testing.

For example, an access point may have multiple transmit antennas and multiple receive antennas, which may allow the access point to implement MIMO with multiple data streams. When a 4×4 access point (with four transmit antennas and four receive antennas or 4×4) is used in wired testing with an electronic device that provides an 8×8 Butler matrix, there are only four sets of orthogonal channels if there are eight clients in the testing with 2×2 channels. Notably, four clients may be connected to output SMA connectors #1 and #2 (such as RF chain #1 connected to output SMA connector #1 and RF chain #2 connected to output SMA connector #2). Similarly, the four remaining clients may be connected to output SMA connectors #3 and #4 (such as RF chain #3 connected to output SMA connector #3 and RF chain #4 connected to output SMA connector #4).

If the wired testing simulates single-user wireless communication (i.e., communication with one client at a time), there is no overlap in the electrical signals associated with the different clients. Nonetheless, the output RF electrical signals include two groups with four clients each that have identical channels, which restricts testing of the spatial diversity that is used in multi-user MIMO (MU-MIMO). Notably, if the testing involves two different clients connected to SMA connectors #1 and #2 and SMA connectors #3 and #4, then MU-MIMO can be evaluated. However, if the testing involves two different clients connected to SMA connectors #1 and #2 or SMA connectors #3 and #4, then the lack of orthogonality impedes realistic testing of MU-MIMO. These limitations often require that MU-MIMO be disabled during wired testing.

### SUMMARY

An electronic device is described. This electronic device includes: N input connectors; M output connectors, where N and M are non-zero integers and M is greater than N; and phase-shift elements that provide predefined phases between the N input connectors and the M output connectors, where the N input connectors and the M output connectors provide a modified Butler matrix. In the modified Butler matrix, N input electrical signals provided to the N input connectors result in N output electrical signals corresponding to the N input electrical signals on N of the M output connectors, where the N output electrical signals are orthogonal to each other. Moreover, the N input electrical signals result in P output electrical signals corresponding to the N input electrical signals on P of the M output connectors, where the P output electrical signals are orthogonal to each other, but are not orthogonal to the N output electrical signals, where P is a non-zero integer. The P output electrical signals are linear combinations of the N input electrical signals in which the N input electrical signals have corresponding second phases, where a dot product of a given one of the N output electrical signals with a given one of the P output electrical signals equals a non-zero predefined value.

For example, N may be 4 and M may be 8, or N may be 4 and M may be 16.

Moreover, the N input electrical signals may be RF electrical signals.

Furthermore, a given input connector or a given output connector may be an SMA connector or another type of coaxial connector.

Note that the N output electrical signals in the linear combinations may have equal amplitudes.

Additionally, the N input electrical signals result in Q output electrical signals corresponding to the N input electrical signals on a Q of the M output connectors, where the Q output electrical signals are orthogonal to each other, but are not orthogonal to the N output electrical signals, where Q is a non-zero integer. The Q output electrical signals are second linear combinations of the N input electrical signals in which the N input electrical signals have corresponding third phases, where a dot product of a given one of the N output electrical signals with a given one of the Q output electrical signals equals a second non-zero predefined value in a set of second non-zero predefined values, where the give second non-zero predefined value is different from the predefined value.

Moreover, the N output electrical signals in the second linear combinations may have equal amplitudes.

In some embodiments, the M output electrical signals have maximal phase separation from each other in an M×M space.

Another embodiment provides a method of performing testing using the electronic device.

Another embodiment provides an RF or wired electronic device that includes the electronic device.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a block diagram illustrating an example of an electronic device in accordance with an embodiment of the present disclosure.

FIG. 2 is a block diagram illustrating an example of an electronic device in accordance with an embodiment of the present disclosure.

FIG. 3 is a flow diagram illustrating an example method for performing testing using the electronic device in FIG. 1 or FIG. 2 in accordance with an embodiment of the present disclosure.

FIG. 4 is a block diagram illustrating an example of an electronic device in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

An electronic device that provides a modified Butler matrix is described. In the modified Butler matrix, N input electrical signals provided to N input connectors result in N output electrical signals corresponding to the N input electrical signals on N of M output connectors, where the N output electrical signals are orthogonal to each other. Moreover, the N input electrical signals result in P output electrical signals corresponding to the N input electrical signals on P of the M output connectors, where the P output electrical signals are orthogonal to each other, but are not orthogonal to the N output electrical signals. The P output electrical signals are linear combinations of the N input electrical signals in which the N input electrical signals have corresponding second phases, where a dot product of a given one of the N output electrical signals with a given one of the P output electrical signals equals a non-zero predefined value.

By providing the M output electrical signals, the electronic device may facilitate testing. For example, the electronic device may facilitate wired testing of an RF electronic device, such as an access point. Notably, the wired testing may simulate MU-MIMO wireless communication with the access point. These simulations may be realistic because the channels in the M output electrical signals may not be identical to each other. Consequently, the electronic device and the associated testing techniques may facilitate development, testing and debugging of RF electronic devices and, thus, may improve the communication performance and the quality of the RF electronic devices.

In the discussion that follows, the electronic device may be used to test or simulate wireless communication associated with a variety of wireless communication protocols, such as: a wireless communication protocol that is compatible with an IEEE 802.11 standard (which is sometimes referred to as ‘Wi-Fi®,’ from the Wi-Fi Alliance of Austin, Tex.), Bluetooth (from the Bluetooth Special Interest Group of Kirkland, Wash.), a cellular-telephone network or data network communication protocol (such as a third generation or 3G communication protocol, a fourth generation or 4G communication protocol, e.g., Long Term Evolution or LTE (from the 3rd Generation Partnership Project of Sophia Antipolis, Valbonne, France), LTE Advanced or LTE-A, a fifth generation or 5G communication protocol, or other present or future developed advanced cellular communication protocol), and/or another type of wireless interface (such as another WLAN interface). For example, an IEEE 802.11 standard may include one or more of: IEEE 802.11a, IEEE 802.11b, IEEE 802.11g, IEEE 802.11-2007, IEEE 802.1 in, IEEE 802.11-2012, IEEE 802.11-2016, IEEE 802.11ac, IEEE 802.11ax, IEEE 802.11ba, IEEE 802.11be, or other present or future developed IEEE 802.11 technologies. Thus, the testing or simulations may correspond to wireless communication in a variety of bands of frequencies, such as: a microwave frequency band, a radar frequency band, 900 MHz, 2.4 GHz, 5 GHz, 6 GHz, 60 GHz, and/or a band of frequencies used by a Citizens Broadband Radio Service or by LTE. In some embodiments, the wireless communication uses multi-user transmission (such as orthogonal frequency division multiple access or OFDMA or MU-MIMO).

Moreover, the electronic device may be used to test a variety of RF electronic devices, such as: a desktop computer, a laptop computer, a subnotebook/netbook, a server, a computer, a tablet computer, a smartphone, a cellular telephone, a smartwatch, a wearable device, a consumer-electronic device, a portable computing device, an access point, a transceiver, a radio node, a base station, communication equipment, a wireless dongle, test equipment, and/or another type of RF electronic device. Note that the radio node may include: an Evolved Node B (eNodeB), a Universal Mobile Telecommunications System (UMTS) NodeB and radio network controller (RNC), a New Radio (NR) gNB or gNodeB (which communicates with a network with a cellular-telephone communication protocol that is other than LTE), etc.

We now describe some embodiments of the electronic device. As discussed previously, linear combinations of N inputs in a Butler matrix provides N orthogonal outputs. In the disclosed electronic device, the number of outputs is increased by relaxing the orthogonality requirement, so that all of the outputs are not orthogonal to each other. Instead, the outputs may have maximal phase separation from each other in an M×M space.

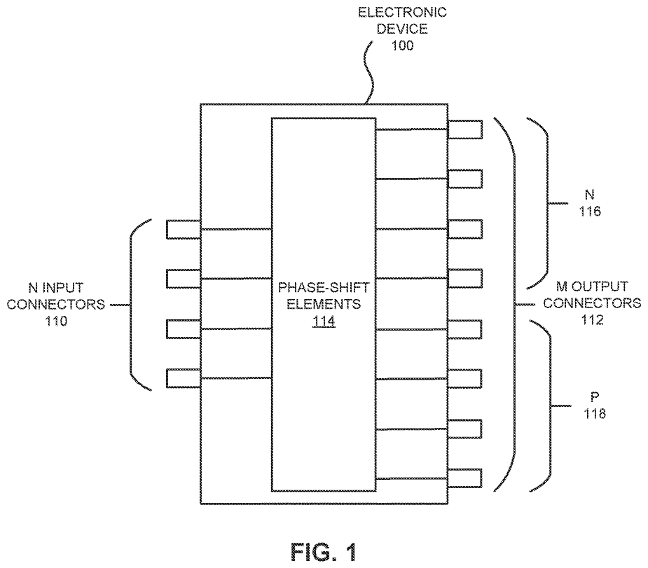

FIG. 1 presents a block diagram illustrating an example of an electronic device 100. This electronic device includes: N input connectors 110; M output connectors 112, where N and M are non-zero integers and M is greater than N; and phase-shift elements 114 that provide predefined phases between the N input connectors and the M output connectors, where the N input connectors 110 and the M output connectors 112 provide a modified Butler matrix. In the modified Butler matrix, N input electrical signals provided to the N input connectors 110 result in N output electrical signals corresponding to the N input electrical signals on N 116 of the M output connectors 112, where the N output electrical signals are orthogonal to each other. Moreover, the N input electrical signals result in P output electrical signals corresponding to the N input electrical signals on a P 118 of the M output connectors 112, where the P output electrical signals are orthogonal to each other, but are not orthogonal to the N output electrical signals, where P is a non-zero integer. The P output electrical signals are linear combinations of the N input electrical signals in which the N input electrical signals have corresponding second phases, where a dot product of a given one of the N output electrical signals with a given one of the P output electrical signals equals a non-zero predefined value.

For example, N may be 4 and M may be 8. Moreover, the N input electrical signals may be RF electrical signals. Furthermore, a given input connector or a given output connector may be an SMA connector or another type of coaxial connector.

Note that the N output electrical signals in the linear combinations may have equal amplitudes. This may ensure that the P output electrical signals correspond to equal amplitudes on transmit antennas in a set of transmit antennas.

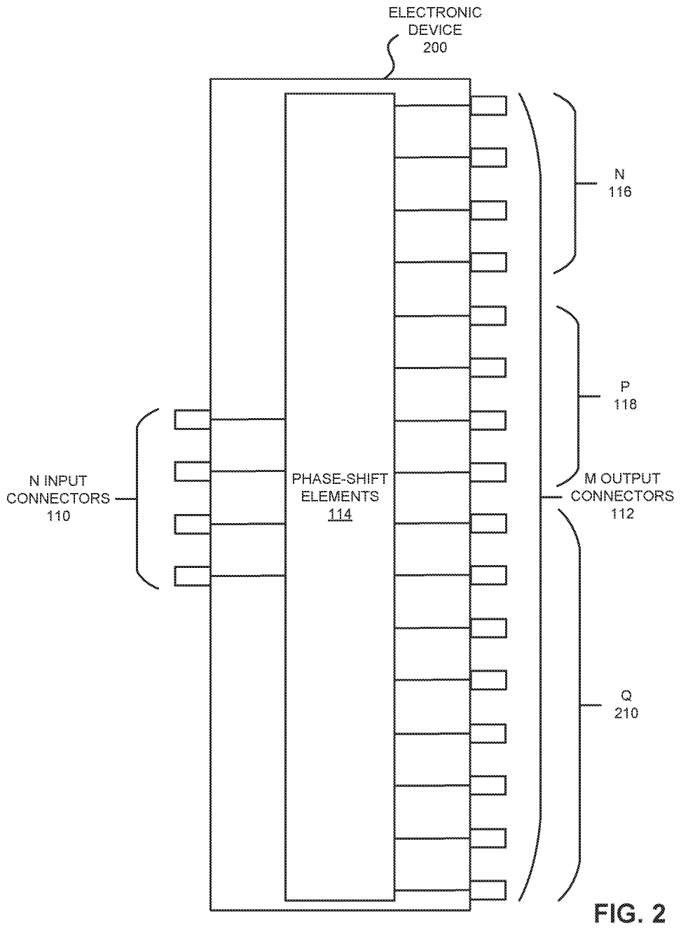

In some embodiments, the modified Butler matrix is extended to a larger number of outputs. This is shown in FIG. 2, presents a block diagram illustrating an example of an electronic device 200. In the modified Butler matrix in FIG. 2, the N input electrical signals result in Q output electrical signals corresponding to the N input electrical signals on a Q 210 of the M output connectors, where the Q output electrical signals are orthogonal to each other, but are not orthogonal to the N output electrical signals, where Q is a non-zero integer. The Q output electrical signals are second linear combinations of the N input electrical signals in which the N input electrical signals have corresponding third phases, where a dot product of a given one of the N output electrical signals with a given one of the Q output electrical signals equals a second non-zero predefined value in a set of second non-zero predefined values, where the give second non-zero predefined value is different from the predefined value.

For example, N may be 4 and M may be 16. Moreover, the N output electrical signals in the second linear combinations may have equal amplitudes.

The M output electrical signals provided by electronic device 100 (FIG. 1) and electronic device 200 may have maximal phase separation from each other in an M×M space. Tables 1-8 illustrate the phase shifts on the output electrical signals and the dot products of the output electrical signals for different embodiments of a 4×8 modified Butler matrix. Tables 9-11 illustrate the phase shifts on the output electrical signals and the dot products of the output electrical signals for different embodiments of a 4×16 modified Butler matrix.

TABLE 1
Phase changes between inputs (columns) and outputs
(rows) for a 4 × 8 phased array or modified Butler matrix.

| | Input #1 | Input #2 | Input #3 | Input #4 |
|---|---|---|---|---|
| Output #1 | 0° | 0° | 0° | 0° |
| Output #2 | 0° | 90° | 180° | −90° |
| Output #3 | 0° | 180° | 0° | 180° |
| Output #4 | 0° | −90° | 180° | 90° |
| Output #5 | 0° | 0° | 0° | 180° |
| Output #6 | 0° | 180° | 180° | 180° |
| Output #7 | 0° | 0° | 180° | 0° |
| Output #8 | 0° | 180° | 0° | 0° |

TABLE 2
Dot products between all outputs of the 4 × 8 phased array
or modified Butler matrix of Table 1.

| | Output #1 | Output #2 | Output #3 | Output #4 | Output #5 | Output #6 | Output #7 | Output #8 |
|---|---|---|---|---|---|---|---|---|
| Output #1 | 1.0 | 0.0 | 0.0 | 0.0 | 0.5 | 0.5 | 0.5 | 0.5 |
| Output #2 | 0.0 | 1.0 | 0.0 | 0.0 | 0.5 | 0.5 | 0.5 | 0.5 |
| Output #3 | 0.0 | 0.0 | 1.0 | 0.0 | 0.5 | 0.5 | 0.5 | 0.5 |
| Output #4 | 0.0 | 0.0 | 0.0 | 1.0 | 0.5 | 0.5 | 0.5 | 0.5 |
| Output #5 | 0.5 | 0.5 | 0.5 | 0.5 | 1.0 | 0.0 | 0.0 | 0.0 |
| Output #6 | 0.5 | 0.5 | 0.5 | 0.5 | 0.0 | 1.0 | 0.0 | 0.0 |
| Output #7 | 0.5 | 0.5 | 0.5 | 0.5 | 0.0 | 0.0 | 1.0 | 0.0 |
| Output #8 | 0.5 | 0.5 | 0.5 | 0.5 | 0.0 | 0.0 | 0.0 | 1.0 |

TABLE 3
Phase changes between inputs (columns) and outputs
(rows) for a 4 × 8 phased array or modified Butler matrix.

| Input 41 | Input 42 | input #3 | Inplit #4 | |
|---|---|---|---|---|
| Output #1 | 0° | 0° | 0° | 0° |
| Oulput #2 | 0° | 90° | 180° | −90° |
| Output #3 | 0° | 180° | 0° | 180° |
| Output #4 | 0° | −90° | 180° | 90° |
| Output #5 | 0° | 0° | 0° | 180° |
| Output #6 | 0° | −90° | 180° | 90° |
| Output #7 | 0° | 90° | 180° | 90° |
| Output #8 | 0° | 180° | 0° | 0° |

TABLE 4
Dot products between all outputs of the 4 × 8 phased array
or modified Butler matrix of Table 3.

| | Output #1 | Output #2 | Output #3 | Output #4 | Output #5 | Output #6 | Output #7 | Output #8 |
|---|---|---|---|---|---|---|---|---|
| Output #1 | 1.0 | 0.0 | 0.0 | 0.0 | 0.5 | 0.5 | 0.5 | 0.5 |
| Output #2 | 0.0 | 1.0 | 0.0 | 0.0 | 0.5 | 0.5 | 0.5 | 0.5 |
| Output #3 | 0.0 | 0.0 | 1.0 | 0.0 | 0.5 | 0.5 | 0.5 | 0.5 |
| Output #4 | 0.0 | 0.0 | 0.0 | 1.0 | 0.5 | 0.5 | 0.5 | 0.5 |
| Output #5 | 0.5 | 0.5 | 0.5 | 0.5 | 1.0 | 0.0 | 0.0 | 0.0 |
| Output #6 | 0.5 | 0.5 | 0.5 | 0.5 | 0.0 | 1.0 | 0.0 | 0.0 |
| Output #7 | 0.5 | 0.5 | 0.5 | 0.5 | 0.0 | 0.0 | 1.0 | 0.0 |
| Output #8 | 0.5 | 0.5 | 0.5 | 0.5 | 0.0 | 0.0 | 0.0 | 1.0 |

TABLE 5
Phase changes between inputs (columns) and outputs
(rows) for a 4 × 8 phased array or modified Butler matrix.

| | Input #1 | Input #2 | Input #3 | Input #4 |
|---|---|---|---|---|
| Output #1 | 0° | 0° | 0° | 0° |
| Output #2 | 0° | 90° | 180° | −90° |
| Output #3 | 0° | 180° | 0° | 180° |
| Output #4 | 0° | −90° | 180° | 90° |
| Output #5 | 0° | 0° | 0° | 180° |
| Output #6 | 0° | −90° | 180° | 90° |
| Output #7 | 0° | 90° | 180° | 90° |
| Output #8 | 0° | 180° | 0° | 0° |

TABLE 6
Dot products between all outputs of the 4 × 8 phased array
or modified Butler matrix of Table 5.

| | Output #1 | Output #2 | Output #3 | Output #4 | Output #5 | Output #6 | Output #7 | Output #8 |
|---|---|---|---|---|---|---|---|---|
| Output #1 | 1.0 | 0.0 | 0.0 | 0.0 | 0.5 | 0.5 | 0.5 | 0.5 |
| Output #2 | 0.0 | 1.0 | 0.0 | 0.0 | 0.5 | 0.5 | 0.5 | 0.5 |
| Output #3 | 0.0 | 0.0 | 1.0 | 0.0 | 0.5 | 0.5 | 0.5 | 0.5 |
| Output #4 | 0.0 | 0.0 | 0.0 | 1.0 | 0.5 | 0.5 | 0.5 | 0.5 |
| Output #5 | 0.5 | 0.5 | 0.5 | 0.5 | 1.0 | 0.0 | 0.0 | 0.0 |
| Output #6 | 0.5 | 0.5 | 0.5 | 0.5 | 0.0 | 1.0 | 0.0 | 0.0 |
| Output #7 | 0.5 | 0.5 | 0.5 | 0.5 | 0.0 | 0.0 | 1.0 | 0.0 |
| Output #8 | 0.5 | 0.5 | 0.5 | 0.5 | 0.0 | 0.0 | 0.0 | 1.0 |

TABLE 7
Phase changes between inputs (columns) and outputs
(rows) for a 4 × 8 phased array or modified Butler matrix.

| | Input #1 | Input #2 | Input #3 | Input #4 |
|---|---|---|---|---|
| Output #1 | 0° | 0° | 0° | 0° |
| Output #2 | 0° | 90° | 180° | −90° |
| Output #3 | 0° | 180° | 0° | 180° |
| Output #4 | 0° | −90° | 180° | 90° |
| Output #5 | 0° | 90° | 0° | −90° |
| Output #6 | 0° | −90° | 180° | −90° |
| Output #7 | 0° | 90° | 180° | 90° |
| Output #8 | 0° | −90° | 0° | 90° |

TABLE 8
Dot products between all outputs of the 4 × 8 phased array
or modified Butler matrix of Table 7.

| | Output #1 | Output #2 | Output #3 | Output #4 | Output #5 | Output #6 | Output #7 | Output #8 |
|---|---|---|---|---|---|---|---|---|
| Output #1 | 1.0 | 0.0 | 0.0 | 0.0 | 0.5 | 0.5 | 0.5 | 0.5 |
| Output #2 | 0.0 | 1.0 | 0.0 | 0.0 | 0.5 | 0.5 | 0.5 | 0.5 |
| Output #3 | 0.0 | 0.0 | 1.0 | 0.0 | 0.5 | 0.5 | 0.5 | 0.5 |
| Output #4 | 0.0 | 0.0 | 0.0 | 1.0 | 0.5 | 0.5 | 0.5 | 0.5 |
| Output #5 | 0.5 | 0.5 | 0.5 | 0.5 | 1.0 | 0.0 | 0.0 | 0.0 |
| Output #6 | 0.5 | 0.5 | 0.5 | 0.5 | 0.0 | 1.0 | 0.0 | 0.0 |
| Output #7 | 0.5 | 0.5 | 0.5 | 0.5 | 0.0 | 0.0 | 1.0 | 0.0 |
| Output #8 | 0.5 | 0.5 | 0.5 | 0.5 | 0.0 | 0.0 | 0.0 | 1.0 |

TABLE 9
Phase changes between inputs (columns) and outputs
(rows) for a 4 × 16 phased array or modified Butler matrix.

| | Input #1 | Input #2 | Input #3 | Input #4 |
|---|---|---|---|---|
| Output #1 | 0° | 0° | 0° | 0° |
| Output #2 | 0° | 90° | 180° | −90° |
| Output #3 | 0° | 180° | 0° | 180° |
| Output #4 | 0° | −90° | 180° | 90° |
| Output #5 | 0° | 90° | 0° | −90° |
| Output #6 | 0° | 0° | 180° | 0° |
| Output #7 | 0° | −90° | 0° | 90° |
| Output #8 | 180° | 0° | 0° | 0° |
| Output #9 | 0° | 70.1640° | −129.6720° | 160.1640° |
| Output #10 | 0° | −19.8360° | 50.3280° | −109.8360° |
| Output #11 | 0° | 160.1640° | −129.6720° | 70.1640° |
| Output #12 | 0° | −109.8360° | −129.6720° | −19.8360° |
| Output #13 | 0° | −109.8360° | 50.3280° | −19.8360° |
| Output #14 | 0° | −19.8360° | −129.6720° | −109.8360° |
| Output #15 | 0° | 70.1640° | 50.3280° | 160.1640° |
| Output #16 | 0° | 160.1640° | 50.3280° | 70.1640° |

TABLE 10
Dot products between outputs of the 4 × 16 phased array
or modified Butler matrix of Table 9.

| | Output #1 | Output #2 | Output #3 | Output #4 | Output #5 | Output #6 | Output #7 | Output #8 |
|---|---|---|---|---|---|---|---|---|
| Output #1 | 1.0 | 0.0 | 0.0 | 0.0 | 0.5 | 0.5 | 0.5 | 0.5 |
| Output #2 | 0.0 | 1.0 | 0.0 | 0.0 | 0.5 | 0.5 | 0.5 | 0.5 |
| Output #3 | 0.0 | 0.0 | 1.0 | 0.0 | 0.5 | 0.5 | 0.5 | 0.5 |
| Output #4 | 0.0 | 0.0 | 0.0 | 1.0 | 0.5 | 0.5 | 0.5 | 0.5 |
| Output #5 | 0.5 | 0.5 | 0.5 | 0.5 | 1.0 | 0.0 | 0.0 | 0.0 |
| Output #6 | 0.5 | 0.5 | 0.5 | 0.5 | 0.0 | 1.0 | 0.0 | 0.0 |
| Output #7 | 0.5 | 0.5 | 0.5 | 0.5 | 0.0 | 0.0 | 1.0 | 0.0 |
| Output #8 | 0.5 | 0.5 | 0.5 | 0.5 | 0.0 | 0.0 | 0.0 | 1.0 |
| Output #9 | 0.1409 | 0.5743 | 0.5662 | 0.5743 | 0.5662 | 0.5743 | 0.1409 | 0.5743 |
| Output #10 | 0.5743 | 0.5662 | 0.5732 | 0.1409 | 0.5743 | 0.5662 | 0.5743 | 0.1409 |
| Output #11 | 0.1409 | 0.5743 | 0.5662 | 0.5743 | 0.1409 | 0.5743 | 0.5662 | 0.5743 |
| Output #12 | 0.5662 | 0.5743 | 0.1409 | 0.5743 | 0.1409 | 0.5743 | 0.5662 | 0.5743 |
| Output #13 | 0.5743 | 0.1409 | 0.5743 | 0.5662 | 0.5743 | 0.5662 | 0.5743 | 0.1409 |
| Output #14 | 0.5662 | 0.5743 | 0.1409 | 0.5743 | 0.5662 | 0.5743 | 0.1409 | 0.5743 |
| Output #15 | 0.5743 | 0.5662 | 0.5743 | 0.1409 | 0.5743 | 0.1409 | 0.5743 | 0.5662 |
| Output #16 | 0.5743 | 0.1409 | 0.5743 | 0.5662 | 0.5743 | 0.1409 | 0.5743 | 0.5662 |

TABLE 11
Dot products between outputs of the 4 × 16 phased array
or modified Butler matrix of Table 9.

| | Output #9 | Output #10 | Output #11 | Output #12 | Output #13 | Output #14 | Output #15 | Output #16 |
|---|---|---|---|---|---|---|---|---|
| Output #1 | 0.1409 | 0.5743 | 0.1409 | 0.5662 | 0.5743 | 0.5662 | 0.5743 | 0.5743 |
| Output #2 | 0.5743 | 0.5662 | 0.5743 | 0.5743 | 0.1409 | 0.5743 | 0.5662 | 0.1409 |
| Output #3 | 0.5662 | 0.5743 | 0.5662 | 0.1409 | 0.5743 | 0.1409 | 0.5743 | 0.5743 |
| Output #4 | 0.5743 | 0.1409 | 0.5743 | 0.5743 | 0.5662 | 0.5743 | 0.1409 | 0.5662 |
| Output #5 | 0.5662 | 0.5743 | 0.1409 | 0.1409 | 0.5743 | 0.5662 | 0.5743 | 0.5743 |
| Output #6 | 0.5743 | 0.5662 | 0.5743 | 0.5743 | 0.5662 | 0.5743 | 0.1409 | 0.1409 |
| Output #7 | 0.1409 | 0.5743 | 0.5662 | 0.5662 | 0.5743 | 0.1409 | 0.5743 | 0.5743 |
| Output #8 | 0.5743 | 0.1409 | 0.5743 | 0.5743 | 0.1409 | 0.5743 | 0.5662 | 0.5662 |
| Output #9 | 1.0 | 0.0 | 0.5 | 0.0 | 0.5 | 0.5 | 0.5 | 0.0 |
| Output #10 | 0.0 | 1.0 | 0.5 | 0.0 | 0.5 | 0.5 | 0.5 | 0.0 |
| Output #11 | 0.5 | 0.5 | 1.0 | 0.5 | 0.0 | 0.0 | 0.0 | 0.5 |
| Output #12 | 0.0 | 0.0 | 0.5 | 1.0 | 0.5 | 0.5 | 0.5 | 0.0 |
| Output #13 | 0.5 | 0.5 | 0.0 | 0.5 | 1.0 | 0.0 | 0.0 | 0.5 |
| Output #14 | 0.5 | 0.5 | 0.0 | 0.5 | 0.0 | 1.0 | 0.0 | 0.5 |
| Output #15 | 0.5 | 0.5 | 0.0 | 0.5 | 0.0 | 0.0 | 1.0 | 0.5 |
| Output #16 | 0.0 | 0.0 | 0.5 | 0.0 | 0.5 | 0.5 | 0.5 | 1.0 |

While the preceding examples illustrated the electronic device with M equal to 8 or 16, more generally M may be an integer greater than N.

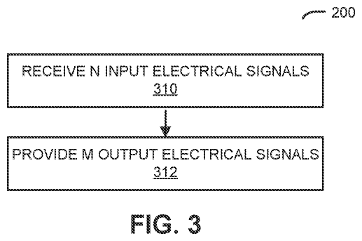

We now describe embodiments of the method. FIG. 3 presents a flow diagram illustrating an example method 300 for performing testing using an electronic device, such as electronic device 100 (FIG. 1) or electronic device 200 (FIG. 2).

During operation, the electronic device may receive N input electrical signals (operation 310) at N input connectors, where N is a non-zero integer.

Then, the electronic device may provide M output electrical signals (operation 312) from M output connectors, where M is a non-zero integer, and M is greater than N. The M output electrical signals may include N output electrical signals corresponding to the N input electrical signals on N of the M output connectors, where the N output electrical signals are orthogonal to each other. Moreover, the N input electrical signals result in P output electrical signals corresponding to the N input electrical signals on P of the M output connectors, where the P output electrical signals are orthogonal to each other, but are not orthogonal to the N output electrical signals, where P is a non-zero integer. The P output electrical signals are linear combinations of the N input electrical signals in which the N input electrical signals have corresponding second phases, where a dot product of a given one of the N output electrical signals with a given one of the P output electrical signals equals a non-zero predefined value.

In some embodiments of method 300, there may be additional or fewer operations. Moreover, there may be different operations. Furthermore, the order of the operations may be changed, and/or two or more operations may be combined into a single operation.

As discussed previously, many types of RF tests are performed by wiring electronic devices to each other. This means that instead of pass over the air through antennas from one electronic device to another, the RF electrical signal passes through RF cables from one electronic device to another. A cabled test allows for significantly more repeatability and more precise control without external interference.

However, cabled tests are often hampered by the number of clients they can reasonably support without the test scenario becoming pathological. When tests are run over the air, every client has a different channel between an access point and the antennas of a client. A tester may need to worry about interference and channel variation during a test, but the tester does not need to worry that two clients will share exactly the same channel. Unfortunately, the best existing technology used to create different channels for clients are phased arrays called Butler matrices. These matrices come in square configurations (such as 4×4 or 8×8) with the same number of inputs and outputs. Butler matrices accomplish two objectives. They distribute an RF electrical signal equally from one input over all the outputs. In addition, a Butler matrix phase shifts (or rotates) the RF electrical signal such that the linear combination of RF electrical signals from the inputs to the outputs ensures that the different channels are orthogonal to each other.

It is pathological and undesirable to have an RF electrical signal from a client not reach all the antennas of an access point. In real environments, the RF electrical signal from a client is typically received at all of the antenna inputs. Consequently, in a cabled environment, we strive to have equal amplitude RF electrical signals arrive at all of the inputs. Having the RF electrical signal be orthogonal is also important, because orthogonality allows an access point to use MIMO, which is useful in information transmission. In general, only paths that have some degree of separation between them can be used to carry separate streams of information.

Moreover, the greater the separation of streams, the easier for separate RF electrical signals to be carried independently. The biggest separation that can be achieved when the RF electrical signals are orthogonal. When two channels are orthogonal to each other, they can carry two streams of information completely independently. Currently, many high-end access points have 4 chains per operating channel. A square Butler matrix creates an artificial channel transforming the antenna inputs/outputs into four orthogonal streams.

However, most high-end clients have two antennas. We say that they are 2×2. Each of the client antennas needs its own stream. This means that with a 4×4 access point and a 4×4 Butler matrix, we can only cable up two 2×2 clients. Two clients are usually insufficient to stress test an access point.

Therefore, we seek a phased array with four inputs and more than four outputs (say 8 or 16 outputs) that would allow us to cable more clients to the access point, but still allow each client to have its own different unique channel. Because of the rules of linear algebra, we cannot add anymore orthogonal channels. We can, however, seek additional channels that have good separation from all the other channels. In a technical sense, we are looking for additional channels that have low dot products with the other channels. We seek these low dot-product channels with the additional constraint that power distribution from the inputs to the output should be uniform.

Tables 1-10 provide two such channel emulation matrices. Notably, these tables illustrate a 4×8 array and a 4×16 array. For the 4×8 array, it can be proven that no new vector/channel can have a better dot product of 0.5 to the existing array. Based on this criterion, we can find a group of another four channels that are completely orthogonal to each other and each of which has a dot product with the Butler matrix channels of 0.5. These vectors are linear transforms of the original Butler matrix channels. For the 4×16 array, we start with the channels from the 4×8 array and seek a group of new vectors that minimize the dot product with the preexisting eight channels. Using a numerical technique with some perturbation, we found a group of eight channels that have a dot product with the preexisting eight channels of 0.5744. Within this new group of eight channels, there are two groups of four orthogonal channels, and between these two groups there is a dot product of 0.5. In some embodiments, this new group of eight channels may be determined using three simultaneous equations for equal amplitude combinations of phase-shifted inputs.

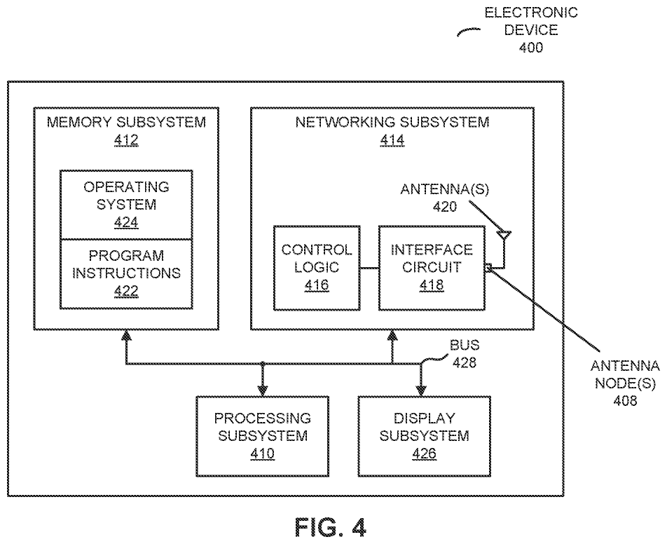

We now describe embodiments of an electronic device, which may be electronic device 100 (FIG. 1) or 200 (FIG. 2), may be another electronic device that includes electronic device 100 (FIG. 1) or 200 (FIG. 2), or may be used in testing. FIG. 4 presents a block diagram illustrating an electronic device 400 in accordance with some embodiments. This electronic device includes processing subsystem 410, memory subsystem 412, and networking subsystem 414. Processing subsystem 410 includes one or more devices configured to perform computational operations. For example, processing subsystem 410 can include one or more microprocessors, ASICs, microcontrollers, programmable-logic devices, graphical processor units and/or one or more digital signal processors (DSPs).

Memory subsystem 412 includes one or more devices for storing data and/or instructions for processing subsystem 410 and networking subsystem 414. For example, memory subsystem 412 can include dynamic random access memory (DRAM), static random access memory (SRAM), and/or other types of memory (which collectively or individually are sometimes referred to as a ‘computer-readable storage medium’). In some embodiments, instructions for processing subsystem 410 in memory subsystem 412 include: one or more program modules or sets of instructions (such as program instructions 422 or operating system 424), which may be executed by processing subsystem 410. Note that the one or more computer programs may constitute a computer-program mechanism. Moreover, instructions in the various modules in memory subsystem 412 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 410.

In addition, memory subsystem 412 can include mechanisms for controlling access to the memory. In some embodiments, memory subsystem 412 includes a memory hierarchy that comprises one or more caches coupled to a memory in electronic device 400. In some of these embodiments, one or more of the caches is located in processing subsystem 410.

In some embodiments, memory subsystem 412 is coupled to one or more high-capacity mass-storage devices (not shown). For example, memory subsystem 412 can be coupled to a magnetic or optical drive, a solid-state drive, or another type of mass-storage device. In these embodiments, memory subsystem 412 can be used by electronic device 400 as fast-access storage for often-used data, while the mass-storage device is used to store less frequently used data.

Networking subsystem 414 includes one or more devices configured to couple to and communicate on a wired and/or wireless network (i.e., to perform network operations), including: control logic 416, an interface circuit 418 and one or more antennas 420 (or antenna elements). (While FIG. 4 includes one or more antennas 420, in some embodiments electronic device 400 includes one or more nodes, such as nodes 408, e.g., a pad, which can be coupled to the one or more antennas 420. Thus, electronic device 400 may or may not include the one or more antennas 420.) For example, networking subsystem 414 can include a Bluetooth networking system, a cellular networking system (e.g., a 3G/4G/5G network such as UMTS, LTE, etc.), a USB networking system, a networking system based on the standards described in IEEE 802.11 (e.g., a Wi-Fi networking system), an Ethernet networking system, and/or another networking system.

In some embodiments, a transmit antenna radiation pattern of electronic device 400 may be adapted or changed using pattern shapers (such as reflectors) in one or more antennas 420 (or antenna elements), which can be independently and selectively electrically coupled to ground to steer the transmit antenna radiation pattern in different directions. Thus, if one or more antennas 420 includes N antenna-radiation-pattern shapers, the one or more antennas 420 may have 2^{N} different antenna-radiation-pattern configurations. More generally, a given antenna radiation pattern may include amplitudes and/or phases of signals that specify a direction of the main or primary lobe of the given antenna radiation pattern, as well as so-called ‘exclusion regions’ or ‘exclusion zones’ (which are sometimes referred to as ‘notches’ or ‘nulls’). Note that an exclusion zone of the given antenna radiation pattern includes a low-intensity region of the given antenna radiation pattern. While the intensity is not necessarily zero in the exclusion zone, it may be below a threshold, such as 3 dB or lower than the peak gain of the given antenna radiation pattern. Thus, the given antenna radiation pattern may include a local maximum (e.g., a primary beam) that directs gain in the direction of an electronic device that is of interest, and one or more local minima that reduce gain in the direction of other electronic devices that are not of interest. In this way, the given antenna radiation pattern may be selected so that communication that is undesirable (such as with the other electronic devices) is avoided to reduce or eliminate adverse effects, such as interference or crosstalk.

Networking subsystem 414 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 400 may use the mechanisms in networking subsystem 414 for performing simple wireless communication between the electronic devices, e.g., transmitting frames and/or scanning for frames transmitted by other electronic devices.

Within electronic device 400, processing subsystem 410, memory subsystem 412, and networking subsystem 414 are coupled together using bus 428. Bus 428 may include an electrical, optical, and/or electro-optical connection that the subsystems can use to communicate commands and data among one another. Although only one bus 428 is shown for clarity, different embodiments can include a different number or configuration of electrical, optical, and/or electro-optical connections among the subsystems.

In some embodiments, electronic device 400 includes a display subsystem 426 for displaying information on a display, which may include a display driver and the display, such as a liquid-crystal display, a multi-touch touchscreen, etc.

Electronic device 400 can be (or can be included in) any electronic device with at least one network interface. For example, electronic device 400 can be (or can be included in): a desktop computer, a laptop computer, a subnotebook/netbook, a server, a computer, a mainframe computer, a cloud-based computer, a tablet computer, a smartphone, a cellular telephone, a smartwatch, a wearable device, a consumer-electronic device, a portable computing device, an access point, a transceiver, a controller, a radio node, a router, a switch, communication equipment, a wireless dongle, test equipment, and/or another electronic device.

Although specific components are used to describe electronic device 400, in alternative embodiments, different components and/or subsystems may be present in electronic device 400. For example, electronic device 400 may include one or more additional processing subsystems, memory subsystems, networking subsystems, and/or display subsystems. Additionally, one or more of the subsystems may not be present in electronic device 400. Moreover, in some embodiments, electronic device 400 may include one or more additional subsystems that are not shown in FIG. 4. Also, although separate subsystems are shown in FIG. 4, in some embodiments some or all of a given subsystem or component can be integrated into one or more of the other subsystems or component(s) in electronic device 400. For example, in some embodiments program instructions 422 are included in operating system 424 and/or control logic 416 is included in interface circuit 418.

Moreover, the circuits and components in electronic device 400 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit (which is sometimes referred to as a ‘communication circuit’ or a ‘means for communication’) may implement some or all of the functionality of networking subsystem 414 and/or other functionality of electronic device 400. The integrated circuit may include hardware and/or software mechanisms that are used for transmitting wireless signals from electronic device 400 and receiving signals at electronic device 400 from other electronic devices. Aside from the mechanisms herein described, radios are generally known in the art and hence are not described in detail. In general, networking subsystem 414 and/or the integrated circuit can include any number of radios. Note that the radios in multiple-radio embodiments function in a similar way to the described single-radio embodiments.

In some embodiments, networking subsystem 414 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals)

In some embodiments, an output of a process for designing the integrated circuit, or a portion of the integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII), Electronic Design Interchange Format (EDIF), OpenAccess (OA), or Open Artwork System Interchange Standard (OASIS). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

In general, electronic device 400 may use a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations performed by electronic device 400 may be implemented using program instructions 422, operating system 424 (such as a driver for interface circuit 418) or in firmware in interface circuit 418. Alternatively or additionally, at least some of the operations performed by electronic device 400 may be implemented in a physical layer, such as hardware in interface circuit 418.

Additionally, electronic device 400 may communicate wireless signals in one or more bands of frequencies, including. a microwave frequency band, a radar frequency band, 900 MHz, 2.4 GHz, 5 GHz, 6 GHz, 60 GHz, and/or a band of frequencies used by a Citizens Broadband Radio Service or by LTE. In some embodiments, the communication between electronic devices uses multi-user transmission (such as OFDMA or MU-MIMO).

While the preceding embodiments illustrated a modified Butler matrix with a N inputs and a larger number M outputs, note that the modified Butler matrix is bidirectional, so the roles of the inputs and outputs can be reversed.

In the preceding description, we refer to ‘some embodiments.’ Note that ‘some embodiments’ describes a subset of all of the possible embodiments, but does not always specify the same subset of embodiments. Moreover, note that numerical values in the preceding embodiments are illustrative examples of some embodiments. In other embodiments of the electronic device and the testing techniques, different numerical values may be used.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. An electronic device, comprising:
N input connectors;
M output connectors, wherein N and M are non-zero integers and M is greater than N; and
phase-shift elements configured to provide predefined phases between the N input connectors and the M output connectors, wherein the electronic device is configured to provide a modified Butler matrix in which:
N input electrical signals provided to the N input connectors result in N output electrical signals corresponding to the N input electrical signals on N of the M output connectors, wherein the N output electrical signals are orthogonal to each other; and
the N input electrical signals result in P output electrical signals corresponding to the N input electrical signals on P of the M output connectors, wherein the P output electrical signals are orthogonal to each other, but are not orthogonal to the N output electrical signals, wherein P is a non-zero integer, wherein the P output electrical signals are linear combinations of the N input electrical signals in which the N input electrical signals have corresponding second phases, and wherein a dot product of a given one of the N output electrical signals with a given one of the P output electrical signals equals a non-zero predefined value.

2. The electronic device of claim 1, wherein N is 4 and M is 8.

3. The electronic device of claim 1, wherein N is 4 and M is 16.

4. The electronic device of claim 1, wherein the N input electrical signals are radio-frequency electrical signals.

5. The electronic device of claim 1, wherein a given input connector or a given output connector is a SubMinature version A (SMA) connector or another type of coaxial connector.

6. The electronic device of claim 1, wherein the N output electrical signals in the linear combinations have equal amplitudes.

7. The electronic device of claim 1, wherein the M output electrical signals have maximal phase separation from each other in an M×M space.

8. The electronic device of claim 1, wherein the electronic device is configured to provide the modified Butler matrix in which:
the N input electrical signals result in Q output electrical signals corresponding to the N input electrical signals on a Q of the M output connectors, wherein the Q output electrical signals are orthogonal to each other, but are not orthogonal to the N output electrical signals, and wherein Q is a non-zero integer; and
the Q output electrical signals are second linear combinations of the N input electrical signals in which the N input electrical signals have corresponding third phases, wherein a dot product of a given one of the N output electrical signals with a given one of the Q output electrical signals equals a second non-zero predefined value in a set of second non-zero predefined values, and wherein the give second non-zero predefined value is different from the predefined value.

9. The electronic device of claim 8, wherein the N output electrical signals in the second linear combinations have equal amplitudes.

10. The electronic device of claim 8, wherein the M output electrical signals have maximal phase separation from each other in an M×M space.

11. A method for performing testing, comprising:
by an electronic device:
receiving, at N input connectors, N input electrical signals; and
providing, at M output connectors, M output electrical signals, wherein the M output electrical signals comprise:
N output electrical signals corresponding to the N input electrical signals on N of the M output connectors, wherein the N output electrical signals are orthogonal to each other; and
P output electrical signals corresponding to the N input electrical signals on P of the M output connectors, wherein the P output electrical signals are orthogonal to each other, but are not orthogonal to the N output electrical signals, wherein P is a non-zero integer, wherein the P output electrical signals are linear combinations of the N input electrical signals in which the N input electrical signals have corresponding second phases, and wherein a dot product of a given one of the N output electrical signals with a given one of the P output electrical signals equals a non-zero predefined value.

12. The method of claim 11, wherein N is 4 and M is 8.

13. The method of claim 11, wherein N is 4 and M is 16.

14. The method of claim 11, wherein the N input electrical signals are radio-frequency electrical signals.

15. The method of claim 11, wherein a given input connector or a given output connector is a SubMinature version A (SMA) connector or another type of coaxial connector.

16. The method of claim 11, wherein the N output electrical signals in the linear combinations have equal amplitudes.

17. The method of claim 11, wherein the M output electrical signals have maximal phase separation from each other in an M×M space.

18. The method of claim 11, wherein the M output electrical signals comprise:
Q output electrical signals corresponding to the N input electrical signals on a Q of the M output connectors, wherein the Q output electrical signals are orthogonal to each other, but are not orthogonal to the N output electrical signals, wherein Q is a non-zero integer, wherein the Q output electrical signals are second linear combinations of the N input electrical signals in which the N input electrical signals have corresponding third phases, wherein a dot product of a given one of the N output electrical signals with a given one of the Q output electrical signals equals a second non-zero predefined value in a set of second non-zero predefined values, and wherein the give second non-zero predefined value is different from the predefined value.

19. The method of claim 18, wherein the N output electrical signals in the second linear combinations have equal amplitudes.

20. The method of claim 18, wherein the M output electrical signals have maximal phase separation from each other in an M×M space.
